(19) United States
(12) Patent Application Publication
(10) Pub. No.: US 2021/0284909 A1
(43) Pub. Date: Sep. 16, 2021

(54) CARBON-BASED FUNCTIONAL MATERIAL AND APPLICATIONS

(71) Applicant: Beijing Xinna International New Materials Technolgy Co., Ltd., Beijing (CN)

(72) Inventors: Zhijiang GUO, Beijing (CN); Gong JIN, Beijing (CN); Jiangping TU, Beijing (CN); Xiuli WANG, Beijing (CN); Lijie CI, Beijing (CN)

(73) Assignee: Beijing Xinna International New Materials Technology Co., Ltd., Beijing (CN)

(21) Appl. No.: 16/328,244

(22) PCT Filed: Aug. 31, 2016
(86) PCT No.: PCT/CN16/97582

§ 371 Date: Feb. 25, 2019

(51) Int. Cl. C09K 17/14; A01C 23/00

(52) U.S. Cl. CPC C09K 17/14; A01C 23/00

(57) ABSTRACT

Provided is a carbon-based functional material (simply as FCN or FCN material) and applications thereof. The carbon-based functional material consists of three elements, namely carbon, nitrogen, and oxygen, having sp2 carbons as the backbone and functional groups R formed on the surface and/or periphery of a carbon backbone substrate, the R functional groups being a combination of groups such as a hydroxyl, carboxyl, ether bond, epoxy, carbonyl, aldehyde, ester, and alkyl. The carbon-based functional material can have interactive effects with plants, microorganisms, and soil environments, provides the function of inducing or regulating biosynthesis and metabolic pathways, also can serve as a carrier for an organically catalyzed synthesis and an intermediate material for biosynthesis, and be prepared as a plant enzyme activating agent and catalyst, a chemical fertilizer additive, a microorganism culturing composition, a soil conditioner, and is broadly applicable in the fields of agricultural production and the environment.

### TECHNICAL FIELD

The present invention belongs to the technical field of new materials, and particularly relates to a novel carbon-based functional material and the application of the material in agriculture and environment.

### BACKGROUND

The organisms and the biosphere on the Earth can be considered to be the cycle of the three elements of C, H and O from inorganic to organic, which is driven by energy. Therefore, the synthesis and metabolism of the organisms and living environment thereof may be influenced and induced by specifically synthesizing organic carbon skeletons from inorganic matters.

Inorganic CO₂ and H₂O has two functions in the process of plant photosynthesis, wherein one is to synthesize an organic carbon skeleton in the form of (CH₂O), and the other is to store energy. Taking an energy-storing (CH₂O) basic carbon skeleton as a raw material, a plant can use energy and absorbed mineral elements to enrich the form of the carbon skeleton. Taking plant C₃ synthesis as an example, six inorganic CO₂ can form a carbon skeleton in the form of (CH₂O)₆ by six C₃ cycles. To complete this process, it is necessary to synthesize a carbon skeleton in the form of C₅H₁₂O₁₁P₂ to participate in catalysis; and meanwhile, intermediates such as C₃H₇O₇ and C₃H₇O₆P can be produced.

At present, documents or patents relating to intervention of biosynthesis and metabolism by converting inorganic matters into organic matters have not been found.

### SUMMARY

An object of the present invention is to provide a novel carbon-based functional material and the application of the carbon-based functional material in agriculture and environment by referring to the theory of biosynthesis and metabolism.

The present invention is implemented by the following technical solutions.

A carbon-based functional material consists of three elements: carbon, hydrogen and oxygen; and a structure of the carbon-based functional material is composed of sp² carbons as a skeleton, and an R functional group is formed on a surface and/or at an edge of a substrate of the carbon skeleton.

The size of the carbon skeleton is 1-100 nm.

The R functional group comprises one or a combination of at least two of a hydroxyl group, a carboxyl group, an ether bond, an epoxy group, a carbonyl group, an aldehyde group, an ester group, and an alkyl group.

The proportion of the three elements of carbon, hydrogen and oxygen are: 40-75 wt % of carbon, 1-4 wt % of hydrogen and 21-59 wt % of oxygen.

The carbon-based functional material is hydrophilic, and forms a uniform carbon-based functional material hydrosol with water.

The carbon-based functional material hydrosol has pH value in the range of 2-4 and conductivity greater than 1.5 ms/cm.

The raw material for preparing the carbon-based functional material is inorganic, and the carbon-based functional material is formed by a single step under a simulated natural environment condition; and combination of the R functional groups vary with the change of natural condition.

An application of a carbon-based functional material comprises any of the above carbon-based functional material; and the carbon-based functional material is used in agriculture field or environment field, interacts with plants, microorganisms and soil environment, and has a function of inducing or regulating biosynthesis and metabolic pathway.

The agricultural field comprises field crops and cash crops.

The field crops at least comprise rice, corn, wheat, and potatoes.

The cash crops at least comprise tobacco, vegetables, flowers, and fruit trees.

The application of the carbon-based functional material in the agriculture field at least comprises: directly applying the carbon-based functional material to soil, or adding the carbon-based functional material to a fertilizer and then applying the fertilizer to the soil through flushing, drip irrigation or sprinkling irrigation.

The present invention has the following advantageous effects.

The carbon-based functional material provided by the present invention uses sp² carbons as a skeleton to form a substrate, and is synthesized by a single step under an artificially simulated natural environmental condition to have an inducing, regulating or catalytic effect; and the R functional group combination varies with the change of the natural condition.

The carbon-based functional material provided by the present invention adopts the carbon, hydrogen and oxygen elements having the same objects as plants, microorganisms and soil, and meanwhile, can induce plant anabolism, provide a carbon source for microorganisms, and regulate the distribution of a carbon sink and nutrients in vertical or horizontal direction in the soil environment, thereby showing a superimposing magnification function.

The application of the carbon-based functional material provided by the present invention is simple, flexible, convenient and diverse. The carbon-based functional material can be directly applied to existing agricultural technologies without additional labor. In the practical application, the FCN can be added to a fertilizer or flushed into the soil with irrigation water, and can also be mixed with water and fertilizer for drip irrigation or sprinkling irrigation. The application of FCN is simple and flexible, can meet not only requirements of factories in the development of FCN-based fertilizers, plant growth promoters, soil conditioners, bio-fertilizer synergists and the like, but also diverse requirements of farmers on independent operations, and can be directly grafted into the existing agricultural technologies.

### BRIEF DESCRIPTION OF THE DRAWINGS

FIG. 1 is a TEM image of an FCN material;

FIG. 2 is an infrared spectrum of the FCN;

FIG. 3A is a carbon element analysis graph of the FCN in an X-ray photoelectron spectroscopy;

FIG. 3B is an oxygen element analysis graph of the FCN in the X-ray photoelectron spectroscopy;

FIG. 4 is a thermogravimetric and functional group analysis graph of the FCN;

FIG. 5 is a table of pH values and conductivities of the FCN;

FIG. 6 is a comparison image showing the effect of the FCN when applied in Arabidopsis;

FIG. 7A is a comparison image showing the effect of the FCN when applied in rice;

FIG. 7B is a chart of different test sites of the FCN;

FIG. 8 is a comparison image showing the effect of the FCN when applied in tobacco; and

FIG. 9 is a simplified structural formula of the FCN material.

### DETAILED DESCRIPTION

The following embodiments are employed to illustrate the technical solutions of the present invention. These embodiments are merely illustrative, are only intended to describe and explain the technical solutions of the present invention, and should not be construed as limiting the technical solutions of the present invention.

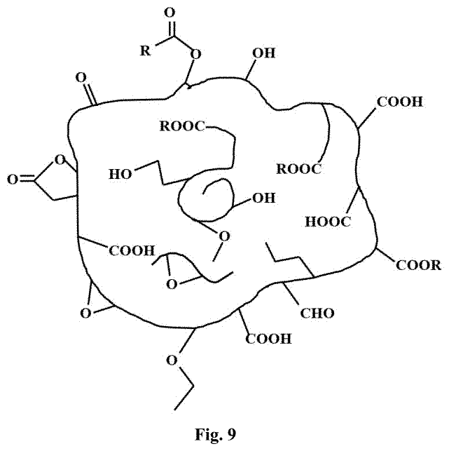

The present invention provides a carbon-based functional material (function carbon Nano, FCN for short). As shown in FIGS. 1-9, the novel carbon-based functional material consists of three elements, namely carbon, hydrogen, and oxygen. A structure of the carbon-based functional material is composed of sp² carbons as a skeleton and an R functional group is formed on the surface and/or at the edge of a carbon skeleton substrate. The R functional group comprises one or combinations of a hydroxyl group, a carboxyl group, an ether bond, an epoxy group, a carbonyl group, an aldehyde group, an ester group, and an alkyl group (such as methyl or an ethyl group), an aryl group, and an ethylene group.

The proportion of the three elements of carbon, hydrogen and oxygen are: 40-75 wt % of carbon, 1-4 wt % of hydrogen and 21-59 wt % of oxygen.

In the present invention, the carbon-based functional material is hydrophilic, and forms a uniform carbon-based functional material hydrosol with water.

The carbon-based functional material hydrosol has a pH value in the range of 2-4 and a conductivity greater than 1.5 ms/cm.

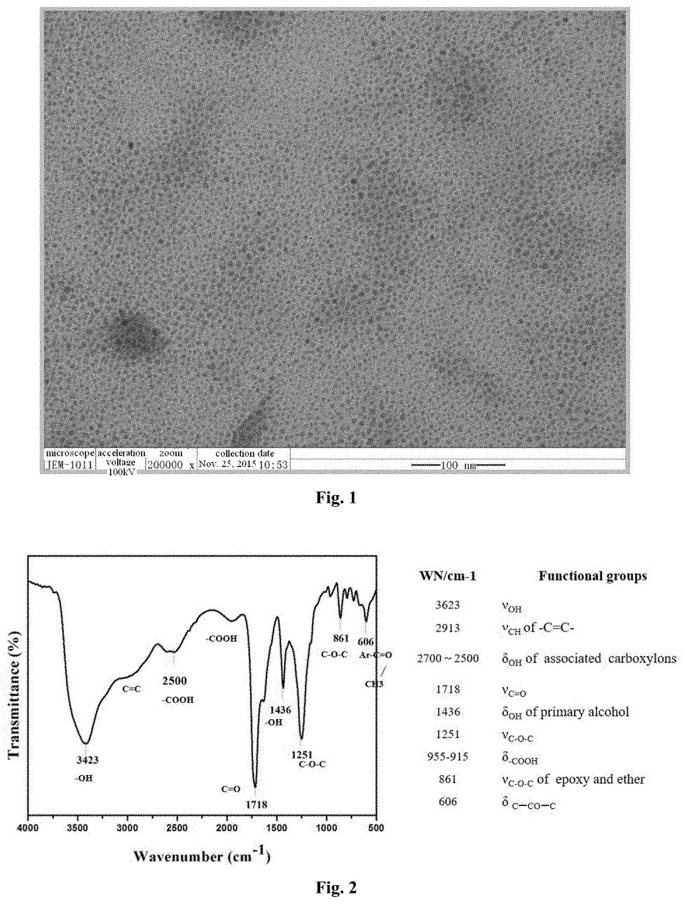

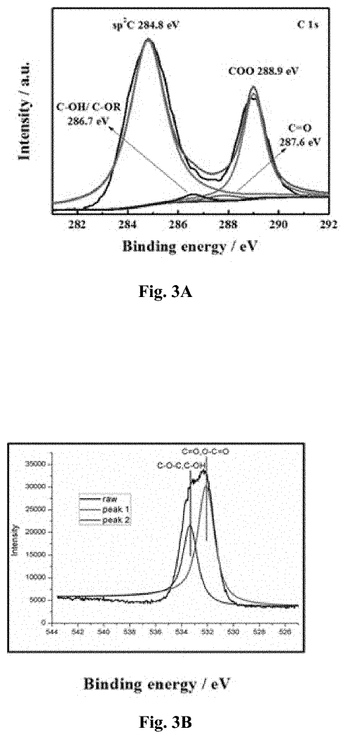

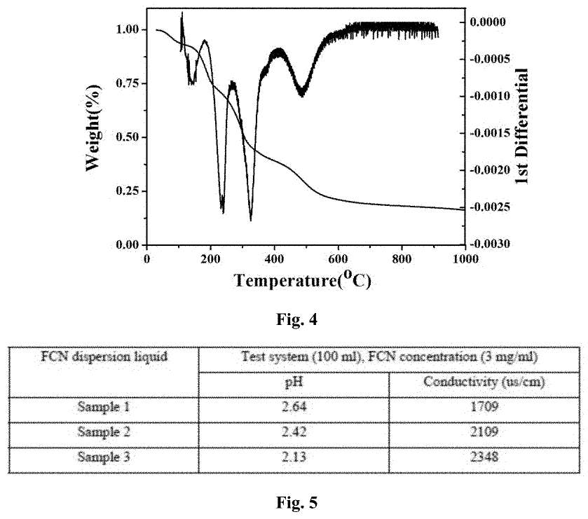

The carbon-based functional material provided by the present invention is granular (as shown in FIG. 1). Through the infrared spectroscopy (FTIR) and the X-ray photoelectron spectroscopy (XPS) analysis of the carbon-based functional material, it can be found that the surface of the carbon-based functional material has a variety of functional groups. It can be seen from the infrared spectroscopy analysis graph (as shown in FIG. 2) that combinations of a hydroxyl group, a carboxyl group, an ether bond, an epoxy group, a carbonyl group, an aldehyde group, an ester group, an alkyl group, and the like are located on the carbon skeleton of the carbon-based functional material. In the X-ray photoelectron spectroscopy (as shown in FIG. 3), from the carbon peak separation results, it is estimated that the surface of a sample may have a hydroxyl group based on the fact that 288.9 ev is binding energy of carbon and the hydroxyl group, and it is speculated that the surface of the sample may have a carboxyl group based on the fact that 287.6 ev is binding energy of carbon and the carboxyl group. From the oxygen peak separation results, 533.2 ev is a binding energy of C—O—C, CO—OH or C—OH in functional groups. Thermal decomposition of the carbon-based functional materials comprises three steps (as shown in FIG. 4): removing water when the temperature is below 100° C.; breaking an oxygen-containing functional group of the material between when the temperature is 100° C. and 700° C.; and calcining the carbon skeleton of the material when the temperature is above 700° C., 200° C. for the carboxyl group, 300° C. for the ester group, 380° C. for the carbonyl group, and 500° C. for the hydroxyl group.

The present invention further comprises the application of the carbon-based functional material which is applied to the field of agriculture or environment. The agricultural field comprises field crops and cash crops. The field crops at least comprise rice, corn, wheat and potatoes, and of course, further comprise others such as soybeans, peanuts, maize, and sorghum.

The cash crops at least comprise tobacco, vegetables, flowers and fruit trees, and further comprise medical materials, beets, sugar cane and the like.

The application of carbon-based functional materials in the field of agriculture at least comprises: directly applying the carbon-based functional material to the soil, or adding the carbon-based functional material to a fertilizer and then applying the fertilizer to the soil through flushing, drip irrigation or sprinkling irrigation.

The carbon-based functional material provided by the present invention can interact with plants, microorganisms, soil environments, and the like, has a function of inducing or regulating biosynthesis and a metabolic pathway, can be used as a carrier for biocatalytic synthesis and an intermediate material for biosynthesis, and can be directly applied to agriculture and environment as a plant enzyme activating agent and catalyst, a chemical fertilizer additive, a microorganism culturing composition, a soil conditioner, or a soil heavy metal collection agent.

The mechanism of the present invention is described as follows. With the sp² carbons as the skeleton substrate of the carbon-based functional material, the structure of the material is relatively stable. Meanwhile, the carbon-based functional material has the properties of ion adsorption and electron storage, such that after being released into the soil environment, the carbon-based functional material will compete with soil colloids for nutrients to adsorb the nutrients fixed in the soil. Moreover, due to small particle size, the carbon-based functional material can be moved to surround plant root system by diffusion or under the influence of the plant rhizosphere power, so as to change the soil and the soil nutrient distribution. The functional groups modified by the surface and the edges of the carbon skeleton are in an excited state, and can interact with the plant root system and the root-related enzymes to achieve the following effects: hydrogen ions released by the carbon-based functional material change the hydrogen ion concentration gradients inside and outside the root cells to promote absorption of the nutrients by the plants; the plants can selectively assimilate the functional groups of the carbon-based functional material to be an intermediate product which is used in a root system synthesis pathway or affects a metabolic pathway; and for rhizosphere flora, the ratio of carbon to nitrogen in the rhizosphere is regulated since the R functional groups of the carbon functional material is active, which is conducive to the development and proliferation of the rhizosphere flora. Therefore, the carbon-based functional material released into the soil, plants, and the nutrient environments can interact with the soil, the plants, and the nutrients through factors such as environmental pH changes, ion adsorption, and water content in soil, so as to be released into organisms and the environment as degradable small molecules or an inducing signal. The carbon-based functional material has the functions of regulating the soil structure, adsorbing soil nutrients, and inducing plant growth and development, such that effects of soil restoration, sustained release of the nutrients and the boosted plant growth are realized.

### Embodiment 1

The components of the obtained carbon-based functional material are analyzed, and the structure and the properties thereof are characterized. The results are discussed as follows.

By analyzing the components of the carbon-based functional material, there are 40-75% of carbon, 1-4% of hydrogen and 21-59% of oxygen in percentage by mass. Further, by observing the carbon skeleton substrate of the prepared carbon-based functional material (see FIG. 1) through the transmission electron microscopy (TEM), it is clear that the carbon-based functional material is in the range of 1-100 nm.

Further, by characterizing the R functional groups through the infrared spectroscopy (see FIG. 2), the corresponding functional groups are listed in the following table:

| No. | Wavelength | Functional Group |
|---|---|---|
| 1 | 3504 | associated hydroxyl group —OH |
| 2 | 3025 | carbon skeleton —C═C— |
| 3 | 2884 | stretching vibration of —CH, possibly, |
| | | of alkyl group —CH₃, —CH₂—, and —CH— |
| | | of an or aldehyde group —CHO |
| 4 | 2700-2500 | stretching and deformation vibration |
| | | of —OH and C—O of carboxylic acid |
| 5 | 1968 | carbon skeleton —C═C═C— |
| 6 | 1700 | carbonyl group —C═O |
| 7 | 1451 | —C—O, —C—N |
| 8 | 1360 | out-of-plane rocking absorption |
| | | of CH₂ of carboxylic acid |
| 9 | 1241 | vibration of C—O—C of an epoxy |
| | | group, possibly, of an ester group |
| 10 | 955-915 | broad peak of —COOH of carboxylic acid |
| 11 | 921, 863 | stretching vibration of —C—O—C |
| | | of an epoxy group |
| 12 | 593 | vibration of hydroxyl group —OH |

Samples of three carbon-based functional materials with different contents of carbon, hydrogen and oxygen are taken. In the first sample, the mass percentages of the carbon atom, the hydrogen atom and the oxygen atom are 67.67%, 3.61%, and 28.72%, respectively; in the second sample, the mass percentages of the carbon atom, the hydrogen atom and the oxygen atom are 53.01%, 2.59% and 44.40%, respectively; and in the third sample, the mass percentages of the carbon atom, the hydrogen atom and the oxygen atom are 48.86%, 3.91%, and 47.23%, respectively. 3 g of each sample is weighed and dispersed in 1 L of water to obtain three kinds of uniform hydrosols. The pH value and the conductivity of each hydrosol in a 100 ml system are measured to obtain the results shown in FIG. 5. The pH values are 2.64, 2.42 and 2.13, respectively, and the conductivities are 1709 us/cm, 2019 us/cm and 2348 us/cm, respectively.

### Embodiment 2

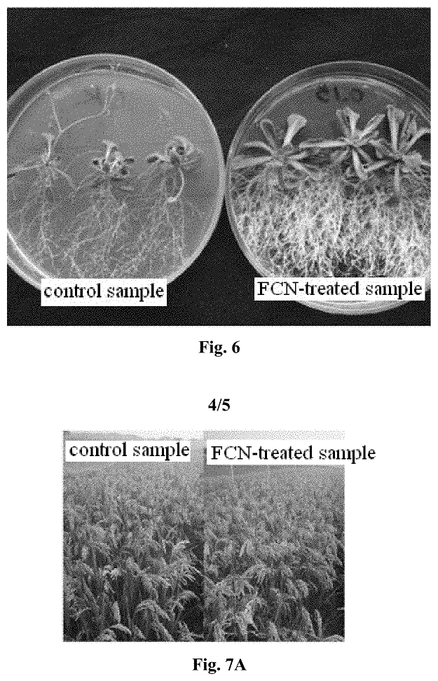

The model plant Arabidopsis is taken as an example (see FIG. 6). The left side is a control sample and the right side is an example with the added FCN to illustrate the effect on Arabidopsis after the addition of the carbon-based functional material.

1) The carbon-based functional material used in this example comprises 48.86% of carbon, 3.91% of hydrogen and 47.23% of oxygen in percentage by mass, and has pH value of 2.13, and conductivity of 2348 us/cm.

2) Arabidopsis transplanted seedlings are prepared; under a sterile condition, Arabidopsis seeds are soaked in sterile deionized water, 20% of a sodium hypochlorite solution was added to sterilize for 3-8 minutes, the sterilized solution was rinsed with sterile water, and the seeds were hill-seeded in a prepared solid medium, and cultured in an illuminated incubator for later use.

3) MS and MS solid medium added with the carbon-based functional material are prepared (MS is a formula designed by Murashige and Skoog in 1962, and is used as the base medium for plant tissue culture and rapid propagation because of the wide application range). 13.2 mg/L of the carbon-based functional material was added to the base MS formula.

4) Transplanting is executed; Arabidopsis transplanted seedlings with uniform growth and 4 leaves are transplanted into the MS and the MS solid medium added with the carbon-based functional material, and cultured vertically, wherein, for set parameters of the illuminated incubator, the temperature is 22-24° C., the light-dark cycle ratio is 16:8, and the humidity is 60-70%.

5) Cultivation is performed for 30 days.

The application effects of the carbon-based functional material on Arabidopsis are described from the perspective of plant morphology, physiology, nutrition and cytology.

(1) With respect to the effect on morphology, responding to the FCN treatment, the Arabidopsis plant grows vigorously, and has a developed root system, and the average fresh weight of each plant is 4.1 times than that of the control sample; meanwhile, the growth and development speed of Arabidopsis is increased, characterized in the large number of roots, the developed root system, and an increased diameter of the root system; and the average growth rate of the new root is 2.8 times than that of the control sample.

(2) With respect to the effect on physiology, after the FCN treatment, the synthesis speed of the auxin in Arabidopsis is increased, and is 1.5 times than that of the control sample.

(3) With respect to the effect on nutrient, after the FCN treatment, the amounts of staple, intermediate and trace elements in the Arabidopsis plant are changed variously. Taking potassium as an example, the absorption of potassium is increased by 8%.

(4) With respect to the effect on cells, when observing the changes of mitochondria and chloroplasts in the leaf surface cells of Arabidopsis, it is found that the number of mitochondria is increased, assimilation products synthesized by the chloroplast do not accumulate, and the source and the sink are coordinated.

It can be seen that the FCN achieves the design goals in the agricultural applications, which are reflected in the following aspects.

1) The FCN regulates the existence form of nutrients necessary for plant growth, which is manifested by a developed root system and vigorous growth of the plant.

2) The FCN can be used as an intermediate for plant anabolism, and it is proved that carbon absorption is increased by supplying carbon assimilation products to the root system.

3) The FCN induces plant synthesis, which is manifested by changes in hormone contents.

### Embodiment 3

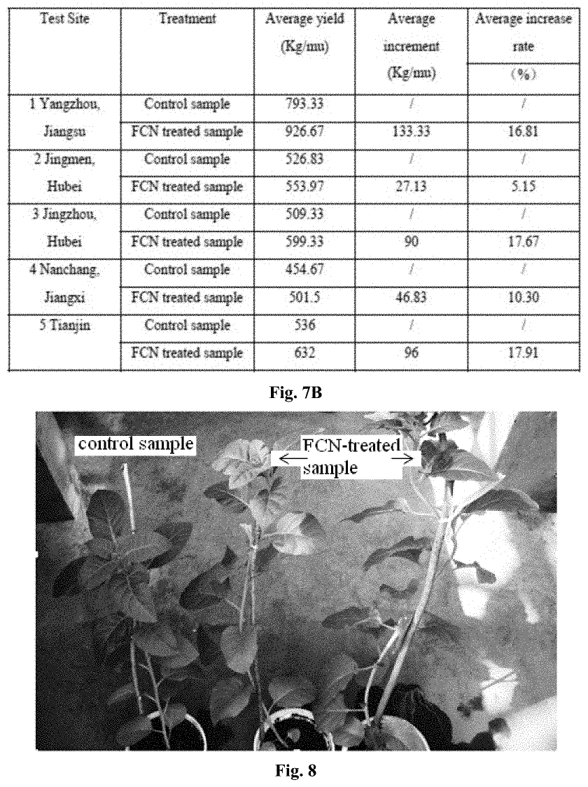

Rice grown in the field is taken as an example (see FIGS. 7A and 7B) to illustrate the effect of the FCN on the rice.

First, FCNs are prepared. In this embodiment, five samples are prepared, and the sample parameters are listed in the following table.

| | | Mass Percentage of | | | | | | |
|---|---|---|---|---|---|---|---|---|
| | | Element | | | | Conductivity | Distributed | |
| No. | FCN | C % | H % | O % | pH | us/cm | Test Site | Comment |
| 1 | Sample 1 | 46.44 | 3.95 | 49.61 | 2.28 | 2213 | Yangzhou, Jiangsu | |
| 2 | Sample 2 | 70.37 | 2.07 | 27.56 | 3.85 | 1521 | Jingmen, Hubei | |
| 3 | Sample 3 | 46.98 | 3.27 | 50.08 | 2.11 | 2478 | Jingzhou, | |
| | | | | | | | Hubei | |
| 4 | Sample 4 | 63.19 | 2.56 | 34.25 | 3.06 | 1689 | Nanchang, | |
| | | | | | | | Jiangxi | |
| 5 | Sample 5 | 42.54 | 3.93 | 53.53 | 2.09 | 2874 | Tianjin | |

Second, rice tests are executed, wherein regions, cultivation mode—fertilization amount, and adding manners of the FCNs are shown in the following table.

| | | | Amount and | |
|---|---|---|---|---|
| | | Cultivation Mode- | Adding | |
| | | Fertilization | Manner | Number of |
| No. | Test Site | Amount | of FCN | Times |
| 1 | Yangzhou, | 16 kg of pure | 25 L of | The fertilizer is |
| | Jiangsu | nitrogen, 20 kg of | the FCN | applied 3 |
| | | P₂O₅, and 6.7 kg of | hydrosol is | times, that |
| | | K₂O are applied | flushed into | is, a base |
| | | to each mu | each mu | fertilizer, a |
| | | (=0.0667 | of the rice | tiller fertilizer, |
| | | hectares) of | field in a | and a |
| | | the rice field. | water and | flower-promoting |
| | | | fertilizer | and flower- |
| | | | coupling | protecting |
| | | | manner. | fertilizer, |
| | | | | which are |
| | | | | applied in a water |
| | | | | and fertilizer |
| | | | | coupling manner. |
| 2 | Jingmen, | 14 kg of pure | 150-200 | The fertilizer is |
| | Hubei | nitrogen, 8 | g/mu, | applied once |
| | | kg of P₂O₅ | mixed with | at the |
| | | and 10 kg of | fertilizer | tillering stage. |
| | | K₂O are applied | and to be | |
| | | to each | broadcasted | |
| | | mu of the | to the rice | |
| | | rice field. | field. | |
| 3 | Jingzhou, | 14 kg of pure | 150-200 | The fertilizer is |
| | Hubei | nitrogen, 8 | g/mu, | applied 3 |
| | | kg of P₂O₅ and | mixed with | times: at |
| | | 10 kg of | fertilizer | the tillering |
| | | K₂O are applied | and to be | stage, the |
| | | to each | broadcasted | booting stage |
| | | mu of the rice | to the rice | and the |
| | | field. | field. | filling stage. |
| 4 | Nanchang, | For base | 50-100 g/mu, | The fertilizer is |
| | Jiangxi | fertilizer, each | put, together | applied 3 |
| | | mu of the rice | with fertilizer, | times: at |
| | | field is | into a tank | the tillering |
| | | applied with | and applied | stage, the |
| | | 13.04 kg of | to the | booting stage |
| | | urea, 37.5 kg of | rice field | and the |
| | | phosphate fertilizer | through drip | filling stage. |
| | | and 5 kg of | irrigation | |
| | | potassium chloride, | under | |
| | | for tiller | the film. | |
| | | fertilizer, each | | |
| | | mu is applied | | |
| | | with 7.83 kg of | | |
| | | urea and 5 kg of | | |
| | | potassium chloride, | | |
| | | and for panicle | | |
| | | fertilizer, each | | |
| | | mu is applied | | |
| | | with 5.22 | | |
| | | kg of urea. | | |
| 5 | Tianjin | 16 kg of pure | 50 L of | The fertilizer is |
| | | nitrogen, 8 | the FCN | applied 5 times, |
| | | kg of P₂O₅ | hydrosol is | that is, 2.5 Kg |
| | | and 10 kg of | flushed into | of pure nitrogen |
| | | K₂O are applied | each mu | is flushed |
| | | to each | of the | into each mu of |
| | | mu of the rice | rice field. | the rice field |
| | | field. | | twice, and the |
| | | | | FCN is directly |
| | | | | flushed into |
| | | | | the rice |
| | | | | field 3 times to |
| | | | | restore the |
| | | | | saline-alkali soil. |

Other cultivation management operations are carried out in accordance with the rice cultivation in the test sites so as to illustrate the effect of the FCN from the yield of rice.

1) With the FCN, the yield per mu of rice in the above five regions is increased by 5.15-17.91%, and a maximum increase is 133.33 Kg per mu, which has typical demonstration significance of increased production. Tianjin is a typical single cropping rice planting region; Yangzhou (Jiangsu), Jingmen and Jingzhou (Hubei), as well as Nanchang (Jiangxi) are typical double cropping rice planting regions.

2) The FCN increases the fertilizer utilization rate, which is manifested by an increased absorption and utilization rate of the fertilizer and an increased utilization rate of grain production.

3) The FCN promotes the growth of rice, which is, during various growth stages of rice, manifested by an increased dry matter accumulation and leaf area index, an improved root oxidation activity and net photosynthetic efficiency of flag leaves, and an increased synthesizing level of zeatin and zeatin nucleosides.

4) As a soil conditioner, the FCN regulates the soil structure of saline-alkaline rice fields, which is manifested by a reduced pH value of the soil within a certain period of time, and a reduced electrical conductivity in the plough layer, such that the growth of rice and the rice root system are promoted.

It can be seen that the FCN achieves the design goals in the agricultural applications, which are reflected in the following aspects.

1) The FCN regulates the existence form of nutrients necessary for plant growth, which is manifested by a developed root system and vigorous growth of the plant.

2) The FCN can be used as an intermediate for plant anabolism, and it is proved that carbon absorption is increased by supplying carbon assimilation products to the root system.

3) The FCN induces plant synthesis, which is manifested by changes in hormone contents.

4) The FCN interacts with soil to restore the saline-alkali soil to the level that can be used by plants.

### Embodiment 4

A model plant, namely, typical cash crop tobacco, is taken as an example (see FIG. 8) to illustrate the effect on tobacco quality of the addition of the FCN.

1) The FCN used in this example comprises 53.01% of carbon, 2.59% of hydrogen and 44.40% of oxygen in percentage by mass, and has pH value of 2.42 and conductivity of 2019 us/cm.

2) Under a vermiculite plant condition, potting is adopted; the 14-14-30 high-potassium compound fertilizer is used and replenished every 5 days in the amount of 10 g dissolved into 1 L water; 5 ml of the FCN is added into water each time; and pH value is adjusted to 6.5.

3) The growth of tobacco is observed; the upper 5 fully spread leaves are collected 40 days, 90 days, 110 days, 120 days and 130 days after transplant; and the absorption amounts of potassium are measured by ICP. The absorption amounts are shown in the following table.

| Potassium | Days After Transplant | | | | |
|---|---|---|---|---|---|
| Content (%) | 40-day | 90-day | 110-day | 120-day | 130-day |
| Control | 2.49 | 1.52 | 1.13 | 2.98 | 0.79 |
| example | | | | | |
| Treated | 4.32 | 2.11 | 1.98 | 3.34 | 1.59 |
| example | | | | | |

The above table shows that after adding the FCN, the K (potassium) content of the upper tobacco leaves is improved, such that the quality of the tobacco leaves can be improved. It can be seen that the FCN improves the absorption of potassium by tobacco, which is manifested by an increased absorption amount.

### Embodiment 5

Under extensive conditions, the effects of the FCN on the yield increase of vegetables, the yield increase and the quality improvement of fruit trees, and improvement of flowers are further illustrated.

1) The FCN is prepared, wherein the FCN comprises 48.29% of carbon, 3.01% of hydrogen and 48.70% of oxygen in percentage by mass, and the pH value of 2.17, and conductivity of 2542 us/cm.

2) Under the field condition, topdressing is applied twice, wherein 10 Kg/mu of nitrogen fertilizer is added each time, and 25 g of the FCN is applied each time. Compared with the control sample without the FCN, the yield per mu of radish is increased by 40%. The average length of radish root is 38 cm and the longest root is 78 cm. This indicates that the FCN increases the absorption of nutrients by radish, and increases the yield of radish.

3) 10 L of the FCN is applied to the rhizosphere of each kiwifruit tree. Compared with a kiwifruit tree without using the FCN, the annual fruiting rate is increased, kiwi fruits are uniform, the sweetness and the taste of the fruits are improved, and the shelf lives of the fruits are prolonged.

4) FCN mixed in water is drip-irrigated to flower Maranta arundinacea. Compared with the control Maranta arundinacea sample, the Maranta arundinacea using the FCN is compact in shape, vigorous in growth, and bright in flower color, and can reach its commercial requirement 7-10 days in advance.

The practical applications of the FCN provided by the present invention in agricultural planting are described as follows. After the addition of the FCN, the phytomass of the crop is increased by more than 5%, and the stress resistance of the crop and the quality of the agricultural product are improved. After adding the FCN into the fertilizer, the utilization efficiency of the fertilizer is increased by more than 30%, and the agricultural product yield rate of the fertilizer is increased. After adding the FCN into the soil, the soil flora is activated, the proliferation rate of the microorganisms is increased, and the content of active nutrients in the soil is increased.

In the foregoing, only some illustrative embodiments of the present invention are described for illustration. It is apparent to those skilled in the art that modifications of the above-described embodiments may be made in various ways without departing from the spirit and scope of the present invention. Therefore, the foregoing drawings and description are illustrative in nature and should not be interpreted to limit the scope of the present invention as defined by the claims.

1. A carbon-based functional material, consisting of three elements: carbon, hydrogen and oxygen, wherein a structure of the carbon-based functional material is composed of sp² carbons as a skeleton, and an R functional group formed on a surface and/or at an edge of the carbon skeleton; wherein
the size of the carbon skeleton is 1-100 nm; and
the R functional group comprises one or a combination of at least two of a hydroxyl group, a carboxyl group, an ether bond, an epoxy group, a carbonyl group, an aldehyde group, an ester group, and an alkyl group.

2. The carbon-based functional material of claim 1, wherein proportion of the three elements of carbon, hydrogen and oxygen are: 40-75 wt % of carbon, 1-4 wt % of hydrogen and 21-59 wt % of oxygen.

3. The carbon-based functional material of claim 1, wherein the carbon-based functional material is hydrophilic, and forms a uniform carbon-based functional material hydrosol with water.

4. The carbon-based functional material of claim 3, wherein the carbon-based functional material hydrosol has pH value in a range of 2-4 and conductivity greater than 1.5 ms/cm.

5. The carbon-based functional material of claim 1, wherein a raw material for preparing the carbon-based functional material is inorganic, and the carbon-based functional material is formed by a single step under a simulated natural environmental condition; and combination of the R functional group changes along with the change of natural condition.

6. A method of using a carbon-based functional material of claim 1 comprising: applying the carbon-based functional material in agriculture field or environment field to interact with plants, microorganisms and soil environment, wherein the carbon-based functional material has a function of inducing or regulating biosynthesis and metabolic pathway.

7. The method of claim 6, wherein the agricultural field comprises field crops and cash crops.

8. The method of claim 7, wherein the field crops at least comprise rice, corn, wheat, and potatoes.

9. The method of claim 7, wherein the cash crops at least comprise tobacco, vegetables, flowers, and fruit trees.

10. The method of claim 6, wherein the application of the carbon-based functional material in the agriculture field at least comprises: directly applying the carbon-based functional material to soil, or adding the carbon-based functional material to a fertilizer and then applying the fertilizer to the soil through flushing, drip irrigation or sprinkling irrigation.
